(19) United States
(12) Patent Application Publication
(10) Pub. No.: US 2012/0010873 A1
(43) Pub. Date: Jan. 12, 2012

(54) SENTENCE TRANSLATION APPARATUS AND METHOD

(75) Inventors: Jeong-Se Kim, Daejeon (KR); Sang-Hun Kim, Daejeon (KR); Seung Yun, Daejeon (KR); Soo-Jong Lee, Daejeon (KR); Sang-Kyu Park, Daejeon (KR)

(73) Assignee: Electronics and Telecommunications Research Institute, Daejeon (KR)

(21) Appl. No.: 13/176,629

(22) Filed: Jul. 5, 2011

(30) Foreign Application Priority Data
Jul. 6, 2010 (KR) 10-2010-0064857

(51) Int. Cl. G06F 17/27

(52) U.S. Cl. 704/9; 704/E15.001

(57) ABSTRACT

Disclosed herein are a sentence translation apparatus and method. The sentence translation apparatus includes a voice recognition unit, a morphemic part-of-speech tagging unit, a pause extraction unit, and a sentence separation unit. The voice recognition unit creates a sentence in a first language based on results of recognition of a voice in a first language. The morphemic part-of-speech tagging unit tags morphemic parts of speech from the sentence in the first language. The pause extraction unit extracts pause information from the voice in the first language. The sentence separation unit separates the sentence in the first language based on information about the morphemic parts of speech tagged by the morphemic part-of-speech tagging unit and the pause information extracted by the pause extraction unit.

### CROSS REFERENCE TO RELATED APPLICATION

This application claims the benefit of Korean Patent Application No. 10-2010-0064857, filed on Jul. 6, 2010, which is hereby incorporated by reference in its entirety into this application.

### BACKGROUND OF THE INVENTION

1. Technical Field

The present invention relates generally to a sentence translation apparatus and method and, more particularly, to a sentence translation apparatus and method which are capable of separating a sentence based on the combination of information about the pauses of a voice and information about the sequences of previously extracted sentence separation-capable morphemic parts of speech.

2. Description of the Related Art

Conventional machine translation systems, when a voice is input, convert the input voice into a sentence and then translate the resulting sentence. In this case, in order to improve the accuracy of translation, a sentence separating process is performed and then separated sentences are translated.

However, in order to compensate for the problem of the accuracy of translation deteriorating due to the occurrence of errors in the separating of a sentence, an attempt to separate a sentence after performing morphemic analysis and tagging the parts of speech has been made. In this case, the recognition of the ranges of sentences is made easy by the morphemic analysis and tagging the parts of speech.

Furthermore, in order to mitigate the phenomenon that the accuracy of translation deteriorates due to a lengthy sentence resulting from the recognition of a voice, an attempt to separate an input sentence into two or more short sentences has been made.

### SUMMARY OF THE INVENTION

Accordingly, the present invention has been made keeping in mind the above problems occurring in the prior art, and an object of the present invention is to provide a sentence translation apparatus and method which are capable of mitigating the phenomenon of the accuracy of translation deteriorating due to the lengthy result of the recognition of a voice because the apparatus and the method are configured to separate a sentence using information about the pauses of a voice and information about morphemic parts of speech when machine translation is performed to provide automatic translation.

Furthermore, another object of the present invention is to provide a sentence translation apparatus and method which are capable of making up for errors using information about the pauses of a voice when the errors occur in the results of tagging the morphemic parts of speech.

In order to accomplish the above objects, the present invention provides a sentence translation apparatus, including a voice recognition unit for creating a sentence in a first language based on results of recognition of a voice in a first language; a morphemic part-of-speech tagging unit for tagging morphemic parts of speech from the sentence in the first language; a pause extraction unit for extracting pause information from the voice in the first language; and a sentence separation unit for separating the sentence in the first language based on information about the morphemic parts of speech tagged by the morphemic part-of-speech tagging unit and the pause information extracted by the pause extraction unit.

The sentence separation unit, when length information of the extracted pause information is equal to or greater than a threshold value, may apply the extracted pause information to the separating of the sentence in the first language.

The sentence separation unit, when the tagged morphemic parts of speech have information about a sequence of sentence separation-capable parts of speech, may apply information about a sequence of the tagged morphemic parts of speech to the separating of the sentence in the first language.

The sentence translation apparatus may further include a sentence separation-capable morphemic part-of-speech information database (DB) for registering information about sentence separation-capable morphemic parts of speech and information about a sequence of the corresponding morphemic parts of speech; wherein the sentence separation unit extracts sequence information corresponding to the tagged morphemic parts of speech from the sentence separation-capable morphemic part-of-speech information DB.

The sentence separation-capable morphemic part-of-speech information DB may include at least one of a morphemic part-of-speech tagging information DB, a declinable word restoration information DB, and a conjunctive pattern information DB.

The sentence separation unit, when the tagged morphemic parts of speech cannot be separate, may restore one or more declinable words of the sentence in the first language to original forms thereof based on the information registered in the declinable word restoration information DB and then apply results of the restoration to the separating of the sentence in the first language.

The sentence separation unit, when the tagged morphemic parts of speech cannot be separate, may separate the sentence in the first language based on conjunctive patterns registered in the conjunctive pattern information DB and then apply results of the separating to the separating of the sentence in the first language.

The sentence translation apparatus may further include a sentence translation unit for translating the separated sentence in the first language into a sentence in a second language.

Additionally, in order to accomplish the above objects, the present invention provides a sentence translation method, including creating a sentence in a first language based on results of recognition of a voice in a first language; tagging morphemic parts of speech from the sentence in the first language; extracting pause information from the voice in the first language; and separating the sentence in the first language based on information about the morphemic parts of speech and the pause information.

The separating may include, when length information of the extracted pause information is equal to or greater than a threshold value, applying the extracted pause information to the separating of the sentence in the first language.

The separating may include, when the tagged morphemic parts of speech have information about a sequence of sentence separation-capable parts of speech, applying information about a sequence of the tagged morphemic parts of speech to the separating of the sentence in the first language.

The separating may include extracting sequence information corresponding to the tagged morphemic parts of speech from a sentence separation-capable morphemic part-of-speech information DB for registering information about sentence separation-capable morphemic parts of speech and information about a sequence of the corresponding morphemic parts of speech.

The sentence separation-capable morphemic part-of-speech information DB may include at least one of a morphemic part-of-speech tagging information DB, a declinable word restoration information DB, and a conjunctive pattern information DB.

The separating may include, when the tagged morphemic parts of speech cannot be separate, restoring one or more declinable words of the sentence in the first language to original forms thereof based on the information registered in the declinable word restoration information DB, and apply results of the restoration to the separating of the sentence in the first language.

The separating may include, when the tagged morphemic parts of speech cannot be separate, separating the tagged morphemic parts of speech in the first language based on information registered in the conjunctive pattern information DB, and apply results of the separating to the separating of the sentence in the first language.

The sentence translation method may further include translating the separated sentence in the first language into a sentence in a second language.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the configuration of a sentence translation apparatus according to the present invention;

FIG. 2 is a block diagram showing the configuration of a sentence separation-capable morphemic part-of-speech information DB according to the present invention;

FIG. 3 is a flowchart showing the overall flow of a sentence translation method according to the present invention;

FIG. 4 is a flowchart showing the detailed flow of the process of tagging morphemic parts of speech according to the present invention; and

FIG. 5 is a flowchart showing the detailed flow of the process of extracting pause information according to the present invention.

### DESCRIPTION OF THE PREFERRED EMBODIMENTS

Reference now should be made to the drawings, in which the same reference numerals are used throughout the different drawings to designate the same or similar components.

Embodiments of the present invention will be described in detail below with reference to the accompanying drawings.

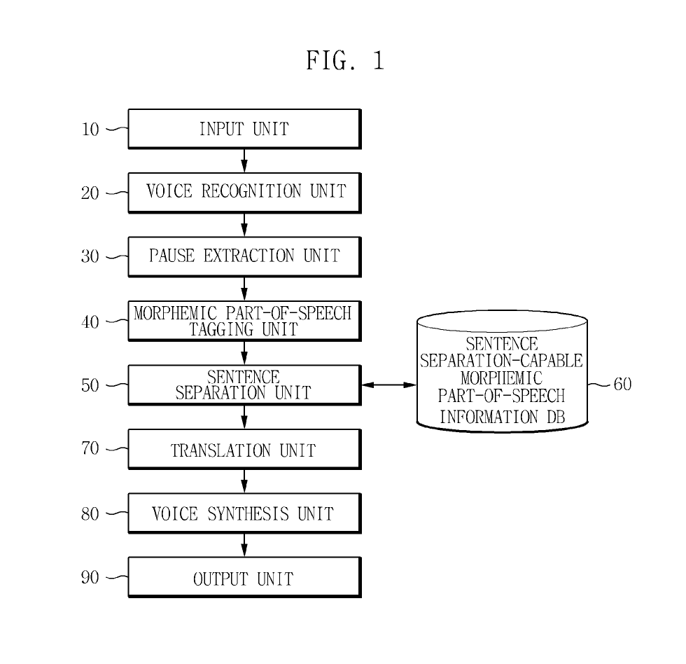

FIG. 1 is a block diagram showing the configuration of a sentence translation apparatus according to the present invention.

As shown in FIG. 1, sentence translation apparatus according to the present invention includes an input unit 10, a voice recognition unit 20, a pause extraction unit 30, a morphemic part-of-speech tagging unit 40, a sentence separation unit 50, a translation unit 70, a voice synthesis unit 80, and an output unit 90. Furthermore, the sentence translation apparatus according to the present invention further includes a sentence separation-capable morphemic pact-of-speech information DB 60. The sentence separation-capable morphemic part-of-speech information DB 60 registers information about sentence separation-capable morphemic parts of speech and information about the sequence of the corresponding morphemic parts of speech.

The input unit 10 is means for receiving a voice or text to be translated, and may be a microphone, a keyboard, a keypad, a touchpad, or the like. In this embodiment of the present invention, a description will be given, with the focus being on the technology for receiving a voice and then translating it.

The voice recognition unit 20, when a voice in a first language is input through an input unit 10, recognizes the voice in a first language. Furthermore, the voice recognition unit 20 creates a sentence in the first language based on the results of the recognition of the voice in the first language.

The pause extraction unit 30 extracts pause information from the voice in the first language input through the input unit 10.

The morphemic part-of-speech tagging unit 40 makes a morphemic analysis of the sentence in the first language, and tags parts of speech based on the results of the morphemic analysis.

An embodiment in which morphemic parts of speech are tagged will now be described.

Example) “ [symbol] [symbol] [symbol] [symbol] [symbol] [symbol] [symbol] ”

When morphemic parts of speech are tagged using the above example sentence, the results thereof are as follows:

->“ [symbol] (adjective)+ [symbol] (suffix)+ [symbol] (closing final ending)+ [symbol] (noun)+ [symbol] (noun)+ [symbol] (object postposition)+ [symbol] (noun)+ [symbol] (verb)+ [symbol] (connective final ending)+ [symbol] (noun)+ [symbol] (object postposition)+ [symbol] (verb)+ [symbol] (connective final ending)+ [symbol] (noun)+ [symbol] (object postposition)+ [symbol] (verb)+ [symbol] (bound noun)+ [symbol] (verb)+ [symbol] (connective final ending)+ [symbol] (adjective)+ [symbol] (pre-final ending)+ [symbol] (closing final ending)”

The morphemic part-of-speech tagging unit 40 stores information about the tagged morphemic parts of speech in the sentence separation-capable morphemic part-of-speech information DB 60.

The sentence separation unit 50 separates the sentence in the first language based on information about the morphemic parts of speech tagged by the morphemic part-of-speech tagging unit 40 and the pause information extracted by the pause extraction unit 30.

At this time, the sentence separation unit 50 performs sentence separating by applying information about the sequence of the morphemic parts of speech and information about whether the corresponding morphemic parts of speech can separate sentences.

In other words, the sentence separation unit 50, when the tagged morphemic parts of speech are morphemic parts of speech capable of separating a sentence, checks whether the sequence of the tagged morphemic parts of speech ends with a closing final ending.

In this case, if the sequence of the morphemic parts of speech ends with a closing final ending, the sentence separation unit 50 applies the information about the morphemic parts of speech to the separating of the sentence in the first language.

If the tagged morphemic parts of speech cannot separate a sentence, the sentence separation unit 50 restores the declinable words of the sentence in the first language into their original forms based on declinable word restoration information registered in the sentence separation-capable morphemic part-of-speech information DB 60, and separates the first sentence in which the declinable words have been restored into their original forms based on conjunctive pattern information registered in the sentence separation-capable morphemic part-of-speech information DB 60.

Thereafter, the sentence separation unit 50 performs sentence separation on the sentence in a first language, which has been restored to its original form and separated.

As an example, when sentence separation is performed using the results of the tagging of the morphemic parts of speech of the previously presented sentence “ [symbol] [symbol] [symbol] [symbol] [symbol] [symbol] [symbol] ,” the sentence separation unit 50 separates the sentence behind a closing final ending or a connective final ending.

That is, the sentence separation unit 50 performs sentence separation, as in [ [symbol] [symbol] [symbol] [symbol] [symbol] [symbol] [symbol] ].

In this case, a mistranslation related to ‘ [symbol] ’ and ‘ [symbol] ’ may occur.

Accordingly, the sentence separation unit 50 performs sentence separation by giving priority to the pause information over the information about the morphemic parts of speech in application. It is assumed that the pause information extracted from the voice of the example original text is as follows:

Example) “ [symbol] <pause> [symbol] <pause> [symbol] [symbol] [symbol] <pause> [symbol] [symbol] ”

In this case, not only can the mistranslation which may be caused by the relationship between ‘ [symbol] ’ and ‘ [symbol] [symbol] ’ be prevented thanks to the pause information, but also the location of the translation of ‘ [symbol] ’ is changed, so that the accuracy of translation can be improved.

Here, the sentence separation unit 50 checks the length information of the extracted pause information, and applies corresponding pause information to the separating of the sentence in the first language only when the length information is equal to or greater than a threshold value.

Finally, the sentence separation unit 50 performs sentence separation based on the pause information, and performs sentence separation by applying the information about the morphemic parts of speech to the results thereof.

The translation unit 70 translates the sentence in the first language, separated by the sentence separation unit 50, into a sentence in a second language. In this case, the translation unit 70 may translate the sentence in the first language into the sentence in the second language by executing a machine translation software module.

The voice synthesis unit 80 synthesizes a voice signal in the second language corresponding to the translated sentence in the second language, and the output unit 90 outputs the synthesized voice signal in the second language to the outside.

Here, if settings have been made to output a sentence in a second language, the voice synthesis unit 80 and the output unit 90 may be omitted.

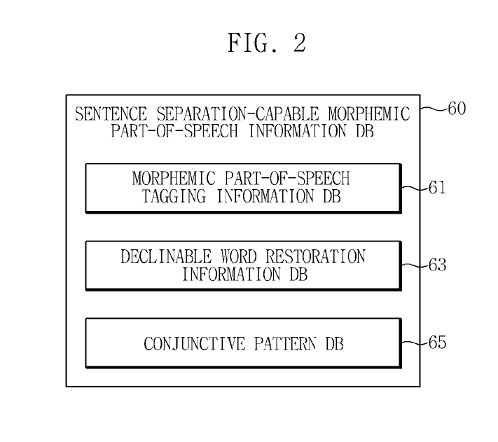

FIG. 2 is a block diagram showing the configuration of the sentence separation-capable morphemic part-of-speech information DB according to the present invention.

As shown in FIG. 2, the sentence separation-capable morphemic part-of-speech information DB 60 includes a morphemic part-of-speech tagging information DB 61, a declinable word restoration information DB, and a conjunctive pattern DB 65.

The morphemic part-of-speech tagging information DB 61 stores the results of the tagging of the morphemic parts of speech of the recognized sentence in the first language.

Furthermore, the declinable word restoration DB 63 stores information which is used to restore declinable words such as connective final endings. The conjunctive pattern DB 65 also stores conjunctive pattern information which is used to restore declinable words in connective final endings and add conjunctions.

Here, when the results of the tagging of the morphemic parts of speech of the sentence in the first language include a closing final ending such as ‘ [symbol] ’ or ‘ [symbol] ’ or a noun such as ‘ [symbol] ’ or ‘ [symbol] ,’ the sentence separation unit 50 may separate the sentence using only the results of the tagging of the morphemic parts of speech.

Meanwhile, when sentence separation cannot be completed once, the sentence separation unit 50 may separate a connective final ending into a closing final ending, a conjunction and the like based on the information stored in the declinable word restoration DB 63 and the conjunctive pattern DB 65, and then perform sentence separation.

An embodiment thereof is as follows:

Example) ‘ [symbol] ’->‘ [symbol] ’+‘ [symbol] ’
‘ [symbol] ’->‘ [symbol] ’+‘ [symbol] ’
‘ [symbol] ’->‘ [symbol] ’+‘ [symbol] ’

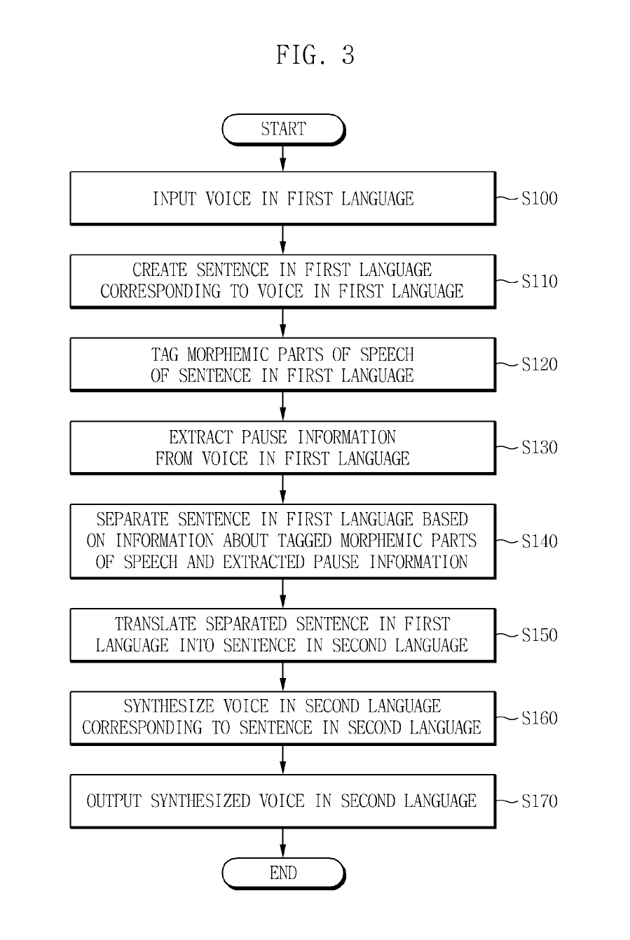

FIG. 3 is a flowchart showing the overall flow of a sentence translation method according to the present invention.

Referring to FIG. 3, the sentence translation apparatus according to the present invention, when a voice in a first language is input at step S100, creates a sentence in the first language corresponding to the voice in the first language at step S110.

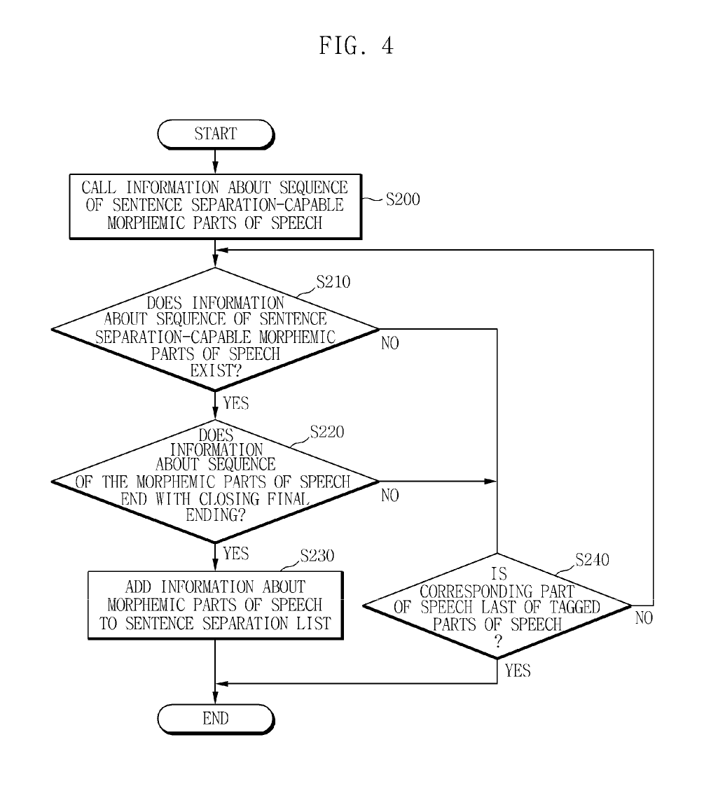

Thereafter, the sentence translation apparatus tags the morphemic parts of speech of the sentence in the first language at step S120. For the detailed operation of the process of tagging morphemic parts of speech, refer to FIG. 4.

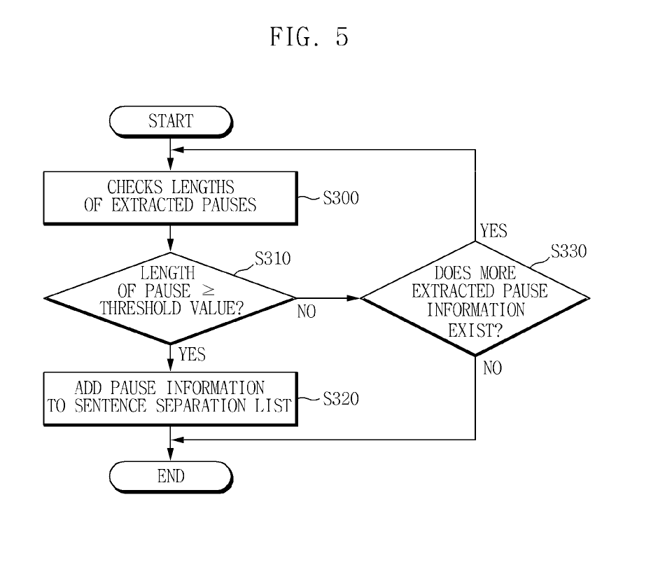

Furthermore, the sentence translation apparatus extracts pause information from the voice in the first language at step S130. For the detailed operation of the process of extracting pause information, refer to FIG. 5.

At this time, the sentence translation apparatus separates the sentence in the first language based on information about the tagged morphemic parts of speech and the extracted pause information obtained at steps S120 and S130, respectively, at step S140. The sentence translation apparatus performs sentence separation using information about the sequence of the tagged morphemic parts of speech.

Here, the sentence translation apparatus performs sentence separation by giving priority to the pause information over the information about the tagged morphemic parts of speech.

Once the sentence in the first language has been separate based on information about the tagged morphemic parts of speech and the extracted pause information, obtained at steps S120 and S130, respectively, the sentence translation apparatus translates the separated sentence in the first language into a sentence in a second language at step S150.

Thereafter, the sentence translation apparatus synthesizes a voice in the second language corresponding to the translated sentence in the second language, obtained at step S150, at step S160, and then outputs the synthesized voice in the second language at step S170.

If a user requests a translated sentence in the second language to be output, the sentence translation apparatus omits steps S160 and S170, and outputs a translated sentence at step S150.

FIG. 4 is a flowchart showing the detailed flow of the process of tagging morphemic parts of speech according to the present invention.

As shown in FIG. 4, the process of tagging morphemic parts of speech calls information about the sequence of the sentence separation-capable morphemic pans of speech from the results of the tagging of the morphemic parts of speech at step S200.

If information about the sequence of the sentence separation-capable morphemic parts of speech does not exist for all of the tagged morphemic parts of speech at steps S210 and S240, the process of tagging morphemic parts of speech is terminated.

Meanwhile, if information about the sequence of the sentence separation-capable morphemic parts of speech exists for the tagged morphemic parts of speech at step S210, whether the corresponding information about the sequence of the morphemic parts of speech ends with a closing final ending is checked.

If the information about the sequence of the morphemic parts of speech ends with a closing final ending at step S220, the sentence translation apparatus adds the corresponding information about the morphemic parts of speech to a sentence separation list at step S230, and terminates the process of tagging morphemic parts of speech.

In contrast, if the information about the sequence of the morphemic parts of speech does not end with a closing final ending at step S220, the sentence translation apparatus terminates the process of tagging morphemic parts of speech.

In this case, the corresponding morpheme parts of speech are subjected to the restoration of declinable words and the addition of conjunctions based on the information stored in the declinable word restoration DB 63 and the conjunctive pattern DB 65 by the sentence separation unit 50, so that the corresponding sentence can be separate.

Thereafter, the sentence separation unit 50 performs sentence separation based on the information about morphemic parts of speech added to the sentence separation list.

FIG. 5 is a flowchart showing the detailed flow of the process of extracting pause information according to the present invention.

Referring to FIG. 5, in the process of extracting pause information, the length information of pause information extracted from a voice in a first language is checked at step S300. In this case, if the pause length is equal to or greater than a preset threshold value at step S310, the corresponding pause information is added to a sentence separation list at step S320.

In contrast, if the length is less than the threshold value, the pause information is excluded from the sentence separation list.

The process of extracting pause information shown in FIG. 5 is terminated after the pieces of length information of all pieces of extracted pause information have been checked at step S330.

Thereafter, the sentence separation unit 50 performs sentence separation based on the pause information added to the sentence separation list.

The present invention is advantageous in that more correct sentence separating can be achieved by making up for errors using pause information even when the errors occur in sentence separating using morphemes because not only morpheme information but also information about the pauses of a voice are utilized to separate a sentence so as to translate the sentence.

Furthermore, the present invention is advantageous in that the accuracy of machine translation can be increased thanks to accurate sentence separation.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A sentence translation apparatus, comprising:
a voice recognition unit for creating a sentence in a first language based on results of recognition of a voice in a first language;
a morphemic part-of-speech tagging unit for tagging morphemic parts of speech from the sentence in the first language;
a pause extraction unit for extracting pause information from the voice in the first language; and
a sentence separation unit for separating the sentence in the first language based on information about the morphemic parts of speech tagged by the morphemic part-of-speech tagging unit and the pause information extracted by the pause extraction unit.

2. The sentence translation apparatus as set forth in claim 1, wherein the sentence separation unit, when length information of the extracted pause information is equal to or greater than a threshold value, applies the extracted pause information to the separating of the sentence in the first language.

3. The sentence translation apparatus as set forth in claim 1, wherein the sentence separation unit, when the tagged morphemic parts of speech have information about a sequence of sentence separation-capable parts of speech, applies information about a sequence of the tagged morphemic parts of speech to the separating of the sentence in the first language.

4. The sentence translation apparatus as set forth in claim 1, further comprising:
a sentence separation-capable morphemic part-of-speech information database (DB) for registering information about sentence separation-capable morphemic parts of speech and information about a sequence of the corresponding morphemic parts of speech;
wherein the sentence separation unit extracts sequence information corresponding to the tagged morphemic parts of speech from the sentence separation-capable morphemic part-of-speech information DB.

5. The sentence translation apparatus as set forth in claim 4, wherein the sentence separation-capable morphemic part-of-speech information DB comprises at least one of a morphemic part-of-speech tagging information DB, a declinable word restoration information DB, and a conjunctive pattern information DB.

6. The sentence translation apparatus as set forth in claim 5, wherein the sentence separation unit, when the tagged morphemic parts of speech cannot be separate, restores one or more declinable words of the sentence in the first language to original forms thereof based on the information registered in the declinable word restoration information DB and then applies results of the restoration to the separating of the sentence in the first language.

7. The sentence translation apparatus as set forth in claim 5, wherein the sentence separation unit, when the tagged morphemic parts of speech cannot be separate, separates the sentence in the first language based on conjunctive patterns registered in the conjunctive pattern information DB and then applies results of the separating to the separating of the sentence in the first language.

8. The sentence translation apparatus as set forth in claim 1, further comprising a sentence translation unit for translating the separated sentence in the first language into a sentence in a second language.

9. A sentence translation method, comprising:
creating a sentence in a first language based on results of recognition of a voice in a first language;
tagging morphemic parts of speech from the sentence in the first language;
extracting pause information from the voice in the first language; and
separating the sentence in the first language based on information about the morphemic parts of speech and the pause information.

10. The sentence translation method as set forth in claim 9, wherein the separating comprises, when length information of the extracted pause information is equal to or greater than a threshold value, applying the extracted pause information to the separating of the sentence in the first language.

11. The sentence translation method as set forth in claim 9, wherein the separating comprises, when the tagged morphemic parts of speech have information about a sequence of sentence separation-capable parts of speech, applying information about a sequence of the tagged morphemic parts of speech to the separating of the sentence in the first language.

12. The sentence translation method as set forth in claim 9, wherein the separating comprises extracting sequence information corresponding to the tagged morphemic parts of speech from a sentence separation-capable morphemic part-of-speech information DB for registering information about sentence separation-capable morphemic parts of speech and information about a sequence of the corresponding morphemic parts of speech.

13. The sentence translation method as set forth in claim 12, wherein the sentence separation-capable morphemic part-of-speech information DB comprises at least one of a morphemic part-of-speech tagging information DB, a declinable word restoration information DB, and a conjunctive pattern information DB.

14. The sentence translation method as set forth in claim 13, wherein the separating comprises, when the tagged morphemic parts of speech cannot be separate, restoring one or more declinable words of the sentence in the first language to original forms thereof based on the information registered in the declinable word restoration information DB,
and applies results of the restoration to the separating of the sentence in the first language.

15. The sentence translation method as set forth in claim 13, wherein the separating comprises, when the tagged morphemic parts of speech cannot be separate, separating the tagged morphemic parts of speech in the first language based on information registered in the conjunctive pattern information DB,
and applies results of the separating to the separating of the sentence in the first language.

16. The sentence translation method as set forth in claim 9, further comprising translating the separated sentence in the first language into a sentence in a second language.
